(19) United States
(12) Patent Application Publication
(10) Pub. No.: US 2005/0118398 A1
(43) Pub. Date: Jun. 2, 2005

(54) Sound dampening laminate

(76) Inventors: David P. Reichwein, Elizabethtown, PA (US); Charles H. Hines, Columbia, PA (US); Sunil Ramachandra, Lancaster, PA (US); Robert A. Hallman, Mt. Joy, PA (US)

Correspondence Address: Douglas E. Winters;Armstrong World Industries, Inc., 2500 Columbia Avenue, P.O. Box 3001, Lancaster, PA, 17604-3001, US

(21) Appl. No.: 10/975,217

(22) Filed: Oct. 27, 2004

Related U.S. Application Data
(60) Provisional application No. 60/515,202, filed on Oct. 28, 2003.

(51) Int. Cl. B32B 3/00; B32B 3/28; B32B 3/30

(52) U.S. Cl. 428/167; 428/322.2; 428/156

(57) ABSTRACT

A sound dampening laminate includes a fiberboard core interposed between two resin impregnated paper layers, one of the paper layers being a design layer comprising a design and the paper layer opposite the design layer being a balancing layer. The fiberboard core has a sound dampening feature, such as a plurality of grooves penetrating from the exposed surface of the balancing layer into the fiberboard core, an energy-absorbing layer interposed between two fiberboard material layers, two layers having different resonant properties or a combination of those features. A sound dampening material, such as silicone rubber, butyl caulk, polyurethane elastomers, ethylene vinyl acetate, or acrylic viscoelastic polymers may be positioned within the grooves.

### FIELD OF THE INVENTION

The present invention relates generally to laminate flooring and in particular to a sound dampening laminate floor panels and the floating floor system comprising the laminate floor panels.

### BACKGROUND OF THE INVENTION

Laminate flooring has a fiberboard core, which may be medium density fiberboard (MDF) or high density fiberboard (HDF). A design layer of resin impregnated paper, typically melamine impregnated paper, or fibrous design layer, about 6 mils thick, is laminated to the fiberboard core. The design layer is typically printed by conventional means. An about 1 mil thick wear layer of resin impregnated paper, typically melamine impregnated paper, or fibrous layer containing hard particles, such as aluminum oxide may be laminated to the design layer opposite the fiberboard. A balancing layer, typically about 6 mil thick resin impregnated paper, typically melamine impregnated paper, or fibrous layer, is laminated to the fiberboard opposite the design layer.

The laminate floor panels of the laminate flooring are typically installed as a floating floor. The laminate boards are not affixed to the subfloor by being adhered with adhesive or fastened with nails, screws or the like. The laminate panels or boards typically have tongues and grooves to interlock them together and in recent years include a click-lock profile that permits the boards to snap together.

The current laminate floor systems have a drawback associated with high frequency in-house noise when walked upon by people wearing shoes, particularly with hard heels. Since the laminate flooring is floating, walking on the flooring creates a hollow or clopping sound. This sound is objectionable since engineered wood floors and solid wood floors, particularly those that are nailed or glued to the subfloor, do not emit such a sound. Therefore, while the visual appearance of the laminate flooring faithfully reproduces the visual appearance of an engineered wood or solid wood floor, the sound generated by walking on it is a telltale give-away that the floor is a laminate.

### SUMMARY OF THE INVENTION

By modifying the structure of existing laminate boards or panels, this “in room” sound can be dampened or reduced. The sound dampening laminate of the present invention has an HDF or MDF core (“fiberboard core”) that includes a sound dampening feature. The fiberboard core is defined as that region of the laminate panel between the resin impregnated paper design layer and the resin impregnated balancing or backing layer. The back or underside of the laminate board may be cut with grooves or slots, preferably in the across machine direction (AMD), i.e. across the width of the laminate, or the HDF or MDF core maybe separated into two layers with a sound dampening or energy-absorbing layer interposed between the two core layers, or the core may include two layers having different resonant properties.

The grooves or slots also may be cut in the machine direction (MD) or at an angle to the AMD in the backside of the laminate panels to improve the sound quality and sound reduction. However, the AMD grooves proved to yield the better results than the MD grooves. Tests showed a 50% reduction of “in room” sound by the AMD slotted panel vs. a standard laminate panel. Also, a combination of AMD and MD slots may be used. Some samples were produced on a milling machine with more precise grooves.

The sound dampening layer may be energy-absorbing or have resonant modes sufficiently different from the other layers of the laminate so the resonant of the composite is reduced. Examples of such materials include filled or unfilled elastomeric materials, softwoods, plywood and some soft metals like lead.

### BRIEF DESCRIPTION OF THE DRAWINGS

FIG. 1 is a bottom view of one embodiment of the sound dampening laminate floor panel of the present invention, showing AMD grooves terminating short of the longitudinal edges of the laminate.

FIG. 2 is a bottom view of a second embodiment of the sound dampening laminate floor panel of the present invention, showing MD grooves terminating short of the transverse edges of the laminate, some of the grooves not being shown.

FIG. 3 is a bottom view of a third embodiment of the sound dampening laminate floor panel of the present invention, showing AMD and MD grooves terminating short of the longitudinal and transverse edges of the laminate, some of the grooves not being shown.

FIG. 4 is a bottom view of a fourth embodiment of the sound dampening laminate floor panel of the present invention, showing AMD grooves traversing the width of the laminate from one edge to the opposite edge.

FIG. 5 is a cross-sectional view of a fifth embodiment of the sound dampening laminate floor panel of the present invention, showing a sound dampening or energy-absorbing layer interposed between two HDF or MDF core layers.

FIG. 6 is a cross-sectional view of a sixth embodiment of the sound dampening laminate floor panel of the present invention, showing two layers having different resonant properties.

### DETAILED DESCRIPTION OF THE INVENTION

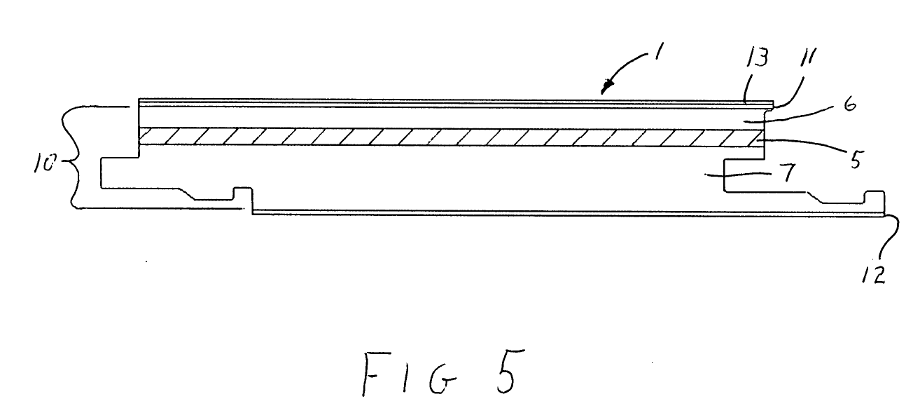

The present invention provides a laminate structure that reduces or dampens the hollow or clopping sound caused by walking on prior art laminate boards or panels by modifying the structure of the fiberboard core to include a sound dampening feature. As shown in FIG. 5, the fiberboard core 10 is defined as that region of the laminate panel 1 between the resin impregnated paper design layer 11 and the resin impregnated balancing or backing layer 12. Wear layer 13 is laminated to the design layer 11.

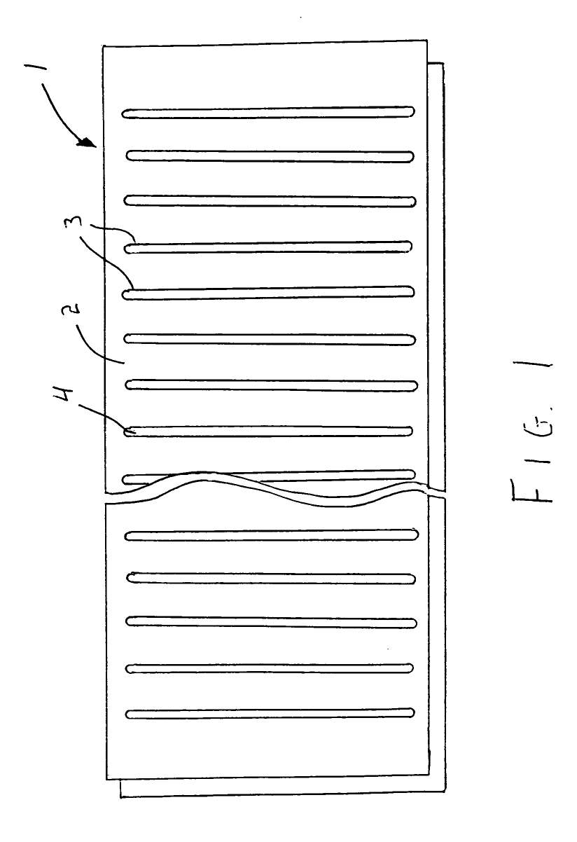

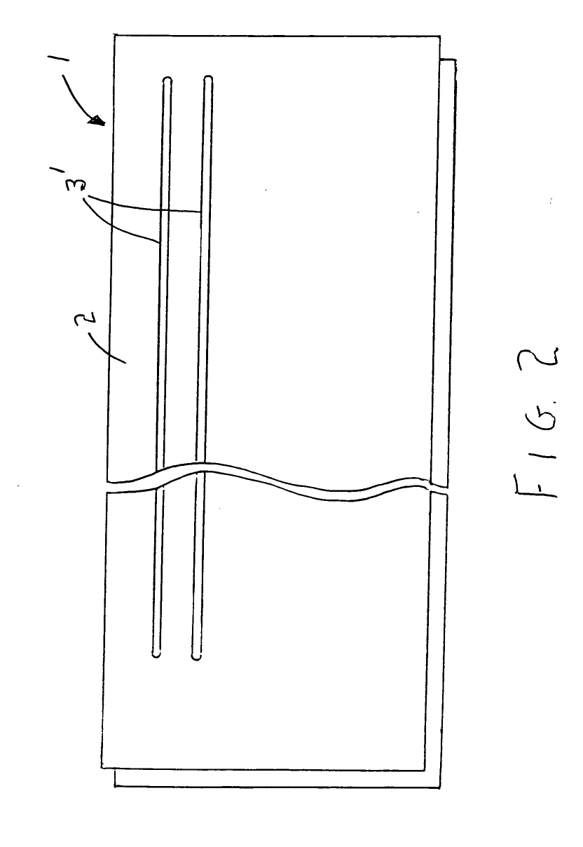

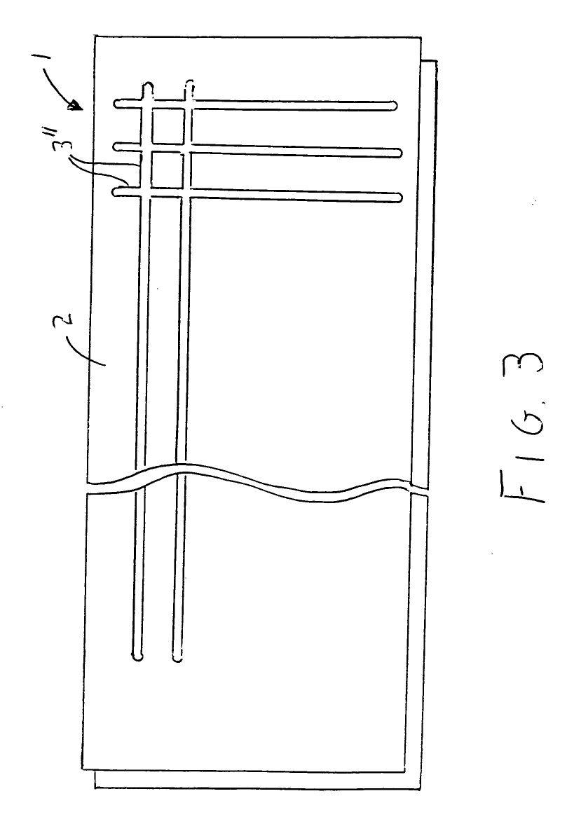

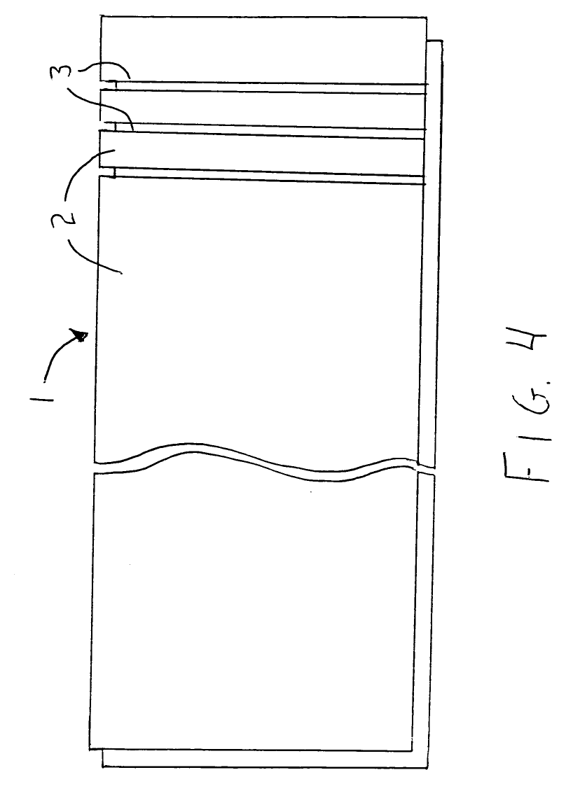

In one embodiment, the back or underside 2 of the laminate board 1 may be cut with grooves or slots 3 that penetrate through the balancing or backing layer and into the core. As shown in FIGS. 1 and 4, the grooves or slots 3 may be in the across machine direction (AMD), i.e. across the width of the laminate. This proved to yield the best results. However cutting grooves or slots 3′ in the backside of the laminate panels in the machine direction (MD), as shown in FIG. 2, or at an angle to the AMD, not shown, also would improve the sound quality and sound reduction. Tests showed a 50% reduction of “in room” sound by the AMD slotted panel vs. a standard laminate panel. The AMD slots reduced the measured noise level by at least 3 dB. Also, as shown in FIG. 3, a combination of AMD and MD slots 3″ may be used.

Some samples were produced on a milling machine with more precise grooves. Grooves or slots cut into the underside of laminate floors reduce the objectionable noise much more effectively than holes drilled in the laminate core from the sides of the board, and presumably more effectively than holes drilled perpendicular to the major surfaces of the laminate.

Though not intended to be limiting, the slots or grooves 3, 3′ and 3″ may be spaced apart about ½ inch to about 2 inches (typically about 1 inch). They may be about 1/16 inch to about ¼ inch (typically about ⅛ inch) in depth. The grooves or slots may be about 1/16 inch to about ¼ inch (typically about ⅛ inch or 3/16 inch) in width. They may be cut using any know device, such as a radial arm saw.

The sound dampening properties of the slots or grooves can be improved by filling the slots or grooves with a sound absorbing material 4. Such sound absorbing material includes silicone rubber, butyl caulk, polyurethane elastomers, ethylene vinyl acetate, or acrylic viscoelastic polymers.

The slots or grooves can traverse the width of the laminate from one edge of the fiberboard to the opposite edge, as shown in FIG. 4, or can be enclosed slots with longitudinal ends that terminate short of the edges, as shown in FIGS. 1 to 3. When the sound dampening material 4 is used, the enclosed slots 3 deter the material from extending into the joints between the laminate boards. Also, by terminating the slots short of the fiberboard edge, damage to the machined edges of the boards is deterred. The space between the edge of the fiberboard and the longitudinal end of the slot may be about ½ inch to about 1.5 inches (typically, about 1 inch).

The Surface Noise Class (SNC) is determined by using a modified ASTM E492-90 test for Impact Isolation Class (IIC). To measure SNC, the sample, which is a 51⅛″×7¾″ laminate panel, is placed in the reverberant chamber, rather than above the reverberant chamber. Other than the sample size and location, the test method of ASTM E492-90 is followed and SNC is calculated in the same manner as IIC. The SNC of prior art laminates is 18 or 19. The SNC of the present invention is at least 22 and in some embodiments at least 23.

Subjective analysis of recorded sounds from a prior test of various flooring types yielded the observation that lower high frequency content gives a “better” sounding floor. An attempt to quantify this used the same fitting routine as described in ASTM E989 but using only frequencies at and above 400 Hz. The difference between this number and the SNC is referred to as a Quality Factor, QF. A higher QF rating indicates the surface nose has less high frequency content.

To measure the Quality Factor (QF), a high frequency SNC (HFSNC) is calculated in the same manner as the SNC using only the data generated at or above 400 Hz. QF=SNC−HFSNC. The QF of the present invention was 0. Therefore a more sensitive test was developed in which an Alternate SNC (ASNC) is calculated from the sound power rather than sound pressure.

Sound pressure level is calculated using the following formula:
SPL=10·log₁₀(P/L₀²) (Formula 1)
Where:

SPL is the sound pressure level

P is the measured power

L₀ is the reference pressure level, 20 μPa or 0.00002 Pascal

An alternate sound power level is calculated using the following formula:
ASPL=10·log₁₀(P²/L₀²) (Formula 2)
Where:

ASPL is the alternate sound power level

P is the measured power

L₀ is the reference pressure level, 20 μPa or 0.00002 Pascal

Samples

Four samples were measured: a 8 mm laminate on a S1830 foam, an 8 mm laminate with slots on the foam, an 8 mm laminate with drilled holes on the foam and an 8 mm laminate with slots adhered to the foam. S1830 is a commercially available underlayment foam from Armstrong World Industries, Inc. The 8 mm laminate was nominally 51⅛″ in length and 7¾″ in width. The slots in the slotted samples were cut AMD and were 3/16″ wide, ⅛″ deep and approximately 1″ apart with about 4.6″ between the ends of the laminate and the first adjacent slot. The slots terminated about 1.2″ from the longitudinal edges. The drilled holes were ⅛″ holes drilled into both sides of the laminate to a depth of about 2″ and with a spacing of about ½″. The 8 mm slotted laminate with attached S-1830 foam was not slotted as deeply as the other slotted laminate, (3/32″ vs. ⅛″ deep). The foam was adhered to the one slotted sample with double backed adhesive tape covering the surface of the balancing layer.

The test was conducted in the 9420 cuft. reverberant chamber. A sub floor structure was constructed of two 4′×8′×7/32″ sheets of plywood and two 4′×8′×¼″ sheets of Luan. Holes were drilled on a 12″ grid, and the 7/32″ plywood was fitted with threaded inserts. The two 7/32″ sheets were placed side by side to form an 8′×8′ layer; and the two sheets of Luan were placed on top, oriented at 90 degrees. Flat-headed machine screws were used to screw the two layers together. This whole assembly rested on a fibrous underlayment to reduce mechanical vibrations exciting the room. Normally, the floor topping would cover the whole 8′×8′ floor; but in this case, the laminate structures were only available in small pieces.

Measurements were made with the tapping machine at four positions as described in ASTM E492. In this study, the laminate structures were all the same thickness and were to be tested on a foam underlayment. In one case, the foam underlayment was adhered to the laminate board. The piece being tested was placed where the tapping machine hammers would fall. The pieces were too narrow to support the feet of the tapping machine so the alternate laminate structures were laid to each side of, but not touching, the sample being tested to support the tapping machine at the proper height. The tapping machine was started and the room closed. The level in the room was measured for each ⅓-octave frequency band from 50 to 10000 Hz at each of the 6 microphones located in the reverberant chamber. The input channel gain for each microphone was adjusted to give 94.0 dB at 1000 Hz with a calibrated sound source prior to the test.

For each hammer position, sound power at the six microphone positions were averaged. These average sound power levels were then averaged for the four hammer positions and then converted to sound pressure level in dB re 20 μPa. The process for determining the IIC rating as described in ASTM E989 was then used to determine a rating for each sample. This rating is being referred to as the Surface Noise Class, SNC.

The tabular data is shown in Table I below.

TABLE I

| | | | | 8 mm |
|---|---|---|---|---|
| | | | | Laminate |
| Frequency | | 8 mm | 8 mm | Slotted on |
| Band | 8 mm | Laminate | Laminate | Attached |
| Hz | Laminate | Slotted | Drilled | Foam |
| 50 | 56.4 | 58.2 | 57.5 | 58.0 |
| 63 | 68.9 | 70.0 | 68.6 | 69.6 |
| 80 | 64.7 | 65.4 | 64.3 | 64.3 |
| 100 | 72.7 | 73.1 | 72.2 | 73.7 |
| 125 | 78.3 | 77.8 | 78.4 | 77.9 |
| 160 | 84.8 | 82.7 | 84.7 | 83.5 |
| 200 | 91.7 | 88.7 | 91.8 | 90.2 |
| 250 | 94.0 | 91.5 | 94.5 | 93.0 |
| 315 | 82.9 | 80.9 | 84.3 | 81.6 |
| 400 | 78.6 | 75.2 | 80.4 | 76.5 |
| 500 | 75.6 | 72.9 | 76.8 | 73.9 |
| 630 | 78.1 | 75.0 | 78.1 | 74.5 |
| 800 | 80.8 | 80.2 | 80.3 | 78.9 |
| 1000 | 81.5 | 82.0 | 80.3 | 80.5 |
| 1250 | 82.0 | 80.8 | 81.1 | 79.3 |
| 1600 | 80.3 | 77.2 | 81.5 | 77.4 |
| 2000 | 78.6 | 78.0 | 80.1 | 73.9 |
| 2500 | 81.2 | 78.6 | 80.6 | 75.7 |
| 3150 | 81.9 | 77.5 | 82.1 | 76.9 |
| 4000 | 81.1 | 76.7 | 80.3 | 75.2 |
| 5000 | 77.9 | 75.3 | 77.7 | 72.3 |
| 6300 | 76.3 | 75.6 | 73.9 | 72.1 |
| 8000 | 71.8 | 72.9 | 72.6 | 67.9 |
| 10000 | 70.3 | 69.9 | 70.2 | 68.4 |
| SNC (in dB) | 18 | 22 | 18 | 23 |
| QF (in dB) | 0 | 0 | 0 | 0 |

As shown above, the SNC for the prior art laminate and the laminate with the drilled holes were 18. The SNC for the two samples of the present invention were 22 and 23. Since a decrease of 3 dB is equivalent to a 50% reduction in noise, the present invention yielded better than 50% improvement.

The prior art 8 mm laminate and the drilled laminate results were similar. The slotted laminate results were significantly different. The calculation of the single number rating, SNC, is controlled by two rules as defined by ASTM E989. The first rule states that there may not be more than 32 deficiencies and second states that there may not be more than 8 deficiencies at any frequency. The SNC for all of the samples tested are controlled by the 8 dB rule at 3150 Hz. Therefore the improvement indicated by difference in SNC between 18 and 22 for the prior art 8 mm thick laminate sample and a slotted laminate sample reflects that the level at 3150 Hz is lower for the slotted sample. The slotted laminate samples were quieter at most frequencies between 160 and 5000 Hz.

The depth of the slots may have an influence. The sample with deeper slots performed better at 250 Hz, while the sample with shallower slots and attached foam performed better at the higher frequencies. Since the QF is based on the difference in performance at higher frequencies and the overall performance, the QF is 0 for all of these samples.

Since the Quality Factor was zero for each the samples, the Alternate Surface Noise Class and Alternate Quality Factor were calculated. The tabular data is shown in Table II below.

TABLE II

| | | | | 8 mm |
|---|---|---|---|---|
| | | | | Laminate |
| Frequency | | 8 mm | 8 mm | Slotted on |
| Band | 8 mm | Laminate | Laminate | Attached |
| Hz | Laminate | Slotted | Drilled | Foam |
| 50 | 21.3 | 24.4 | 22.8 | 23.9 |
| 63 | 47.9 | 48.4 | 45.1 | 47.1 |
| 80 | 37.5 | 38.1 | 36.2 | 36.1 |
| 100 | 52.6 | 53.6 | 51.7 | 54.5 |
| 125 | 64.0 | 63.3 | 64.4 | 63.3 |
| 160 | 76.8 | 72.5 | 76.7 | 74.1 |
| 200 | 90.9 | 85.0 | 91.1 | 87.9 |
| 250 | 94.6 | 89.7 | 95.8 | 92.9 |
| 315 | 72.9 | 69.1 | 75.9 | 70.5 |
| 400 | 65.2 | 58.4 | 68.7 | 60.8 |
| 500 | 59.5 | 53.9 | 61.7 | 55.9 |
| 630 | 64.2 | 57.6 | 63.9 | 56.6 |
| 800 | 69.0 | 67.7 | 68.0 | 65.1 |
| 1000 | 69.9 | 70.8 | 67.5 | 67.9 |
| 1250 | 70.3 | 67.8 | 68.5 | 64.9 |
| 1600 | 66.6 | 60.2 | 68.9 | 60.6 |
| 2000 | 62.4 | 61.2 | 65.3 | 53.0 |
| 2500 | 67.0 | 61.8 | 65.8 | 56.1 |
| 3150 | 68.2 | 59.3 | 68.5 | 58.1 |
| 4000 | 66.0 | 57.1 | 64.4 | 54.1 |
| 5000 | 59.3 | 53.7 | 58.5 | 47.8 |
| 6300 | 54.8 | 53.6 | 50.1 | 46.4 |
| 8000 | 44.6 | 46.8 | 46.2 | 36.7 |
| 10000 | 40.6 | 39.6 | 40.2 | 36.6 |
| ASNC (in dB) | 23 | 28 | 22 | 25 |
| AQF (in dB) | 7 | 11 | 7 | 15 |

The prior art 8 mm laminate and the drilled laminate results were similar. The slotted results were significantly different. Not only were the slotted results at 250 Hz lower than the non-slotted samples, but at most higher frequencies they were significantly lower as well. Based on the subjective results obtained previously, this implies the slotted laminates are both quieter and better sounding that the non-slotted laminates. The depth of the slots may have an influence. The sample with deeper slots performed better at 250 Hz, while the sample with shallower slots and attached foam performed better at the higher frequencies.

The ASNC of the prior art laminates was 22. The ASNC of the present invention is at least 25, in some embodiments at least 27, and in other embodiments at least 28. The AQF of the present invention is at least 10, in some embodiments at least 12, and in other embodiments at least 15.

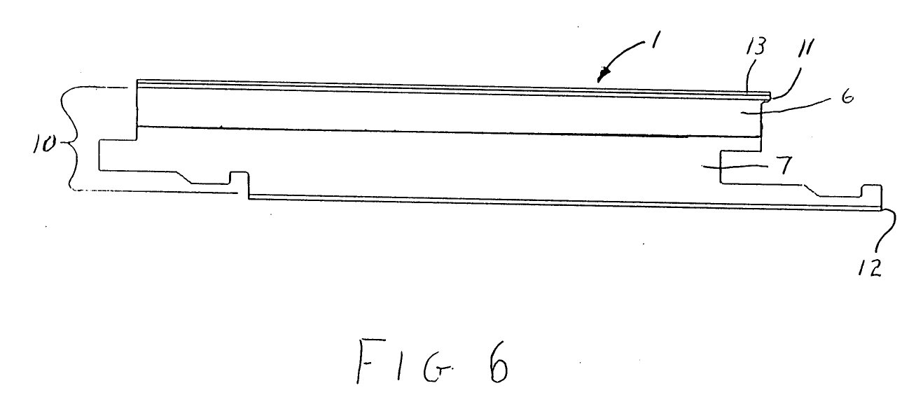

In another embodiment, shown in FIGS. 5 and 6, the technique for reducing noise from impacts on laminate flooring is accomplished through the use of dissimilar layers 5, 6 and 7 or 6′ and 7′. One of the dissimilar layers may be energy-absorbing 5 or have resonant modes sufficiently different from the other layers of the fiberboard core so the resonant of the composite is reduced.

When an energy-absorbing layer 5 is sandwiched between two layers of fiberboard core material 6 and 7, the core material layers 6 and 7 should not be the same thickness so the resonant modes of each layer occur at different frequencies. See FIG. 5. The energy-absorbing layer 5 will be most efficient when it is not located at the center of the structure since the strain in the plane parallel to and centered between the top and bottom of the floor is a minimum for a homogeneous structure. The energy-absorbing layer may be any material that undergoes some plastic deformation under stress. Examples include an adhesive, filled or unfilled elastomeric materials, softwoods, plywood and some soft metals like lead, tin or zinc.

Alternately, as shown in FIG. 6, the use of at least two layers 6′ and 7′ that have resonant properties that are significantly different will reduce the non-coincident resonance modes in the composite. This includes laminates of various composition or density, filled or unfilled elastomeric materials, softwoods, plywood and some soft metals like lead, tin or zinc.

1. A sound dampening laminate floor panel comprising a fiberboard core interposed between two resin impregnated paper layers, one of the paper layers being a design layer comprising a design, the paper layer opposite the design layer being a balancing layer, wherein the fiberboard core comprises a sound dampening feature.

2. The laminate floor panel of claim 1, wherein the sound dampening feature is selected from the group consisting of a plurality of grooves penetrating from the exposed surface of the balancing layer into the fiberboard core, an energy-absorbing layer interposed between two fiberboard material layers, two layers having different resonant properties and a combination thereof.

3. The laminate floor panel of claim 1, wherein the sound dampening feature is a plurality of substantially parallel grooves penetrating from the exposed surface of the balancing layer into the fiberboard core.

4. The laminate floor panel of claim 3, wherein the plurality of grooves traverse the fiberboard core and balancing layer from one edge of the fiberboard core and balancing layer to the opposite edge of the fiberboard core and balancing layer.

5. The laminate floor panel of claim 3, wherein the plurality of grooves have longitudinal ends that terminate short of the edges of the fiberboard and balancing layer.

6. The laminate floor panel of claim 3, wherein the plurality of grooves is aligned substantially perpendicular to the length of the laminate panel.

7. The laminate floor panel of claim 3, further comprising a sound dampening material positioned within the plurality of grooves.

8. The laminate floor panel of claim 7, wherein the sound dampening material is selected from the group consisting of silicone rubber, butyl caulk, polyurethane elastomers, ethylene vinyl acetate, and acrylic viscoelastic polymers.

9. The laminate floor panel of claim 1, wherein the Alternate Surface Noise Class is at least 25.

10. The laminate floor panel of claim 1, wherein the Alternate Quality Factor is at least 10.

11. The laminate floor panel of claim 1, wherein the sound dampening feature is an energy-absorbing layer interposed between two fiberboard material layers, the energy-absorbing layer comprising a material selected from the group consisting of an adhesive, a filled elastomeric material, an unfilled elastomeric material, a softwood, a plywood and a soft metal.

12. The laminate floor panel of claim 11, wherein the fiberboard material layers have different thicknesses.

13. The laminate floor panel of claim 1, wherein the sound dampening feature is two layers having different resonant properties, one of the layers comprising fiberboard material and the other layer comprising a material selected from the group consisting of a filled elastomeric material, an unfilled elastomeric material, a softwood, a plywood and a soft metal.

14. The laminate floor panel of claim 1, wherein the sound dampening feature is two fiberboard material layers having different resonant properties, the two layers of fiberboard material having different compositions or different densities.

15. A floating floor system comprising a plurality of the laminate floor panels of claim 1.

16. A floating floor system comprising a plurality of the laminate floor panels of claim 2.

17. A floating floor system comprising a plurality of the laminate floor panels of claim 3.

18. A floating floor system comprising a plurality of the laminate floor panels of claim 7.

19. A floating floor system comprising a plurality of the laminate floor panels of claim 11.

20. A floating floor system comprising a plurality of the laminate floor panels of claim 13.

21. A floating floor system comprising a plurality of the laminate floor panels of claim 14.
